(19) United States
(12) Patent Application Publication
(10) Pub. No.: US 2007/0024092 A1
(43) Pub. Date: Feb. 1, 2007

(54) Method for mounting a roof module on the bodywork of a vehicle

(76) Inventors: Thomas Zirbs, Weil der Stadt (DE); Thomas Zitterbart, Dietenheim (DE)

Correspondence Address: STEPHAN A. PENDORF, P.A., PENDORF & CUTLIFF, 5111 MEMORIAL HIGHWAY, TAMPA, FL, 33634, US

(21) Appl. No.: 10/553,089

(22) PCT Filed: Feb. 18, 2004
(86) PCT No.: PCT/EP04/01520

§ 371 Date: Jul. 12, 2006

(30) Foreign Application Priority Data
Apr. 9, 2003 (DE) 10316115.5

(51) Int. Cl. B60J 7/00

(52) U.S. Cl. 296/214

(57) ABSTRACT

The method is used for mounting a roof module (10) on a roof frame structure (12), having a roof opening (20), of a vehicle body (14), wherein the roof module (10), which contains a roof module panel (16) and a roof liner (18), is brought from outside into a defined inserted position relative to the roof opening (20), thereby forming an adhesive connection with the roof frame structure (12), and wherein the roof liner (18) in the inserted position has at least one roof liner portion (24) protruding over a roof frame member (22) of the roof frame structure (12). Provision is made here for the roof module (10) to be positioned at least temporarily relative to the roof opening (20) by means of a movement component in the longitudinal direction (X) of the vehicle body in such a way that the roof module (10) is initially brought into a threaded-in position at a distance from the roof frame structure (12), in which position the roof liner portion (24) is positioned opposite an inner region (28) of the roof frame member (22), and in that the roof module (10) is subsequently brought into the inserted position by means of a feeding movement directed substantially perpendicularly to the bonding face (26), this movement being favorable for the adhesive connection.

### CROSS REFERENCE TO RELATED APPLICATION

This application is a national stage of PCT/EP2004/001520 filed Feb. 18, 2004 and based upon DE 103 16 115.5 filed Apr. 9, 2003 under the International Convention.

### BACKGROUND OF THE INVENTION

1. Field of the Invention

The invention relates to a method for mounting a roof module on a roof frame structure, having a roof opening, of a vehicle body, wherein the roof module, which contains a roof module panel and a roof liner, is brought from outside into a defined inserted position relative to the roof opening, thereby forming an adhesive connection with the roof frame structure, and wherein the roof liner in the inserted position has at least one roof liner portion protruding over a roof frame member of the roof frame structure.

2. Related Art of the Invention

Methods of the type mentioned above are known already. For example, DE 197 09 016 A1 discloses a vehicle roof and a method for mounting the vehicle roof on a body. Provided for this purpose is a vehicle roof module which is provided with a roof liner and is intended to be inserted vertically downward from outside into a body frame. The body frame is provided with a body opening tailored to the vehicle roof module. During the insertion operation, the regions of the roof liner which protrude over the edge of the body opening are temporarily bent over in such a way that they do not constitute an obstacle to the operation of inserting the vehicle roof module into the body frame. Once the defined inserted position has been assumed, the vehicle roof module is fastened to the body frame by means of an adhesive connection.

### SUMMARY OF THE INVENTION

It is the object of the invention to propose an alternative method for mounting a roof module on a vehicle body.

The method according to the invention is characterized in that the roof module is at least temporarily positioned relative to the roof opening by means of a movement component in the longitudinal direction of the vehicle body in such a way that the roof module is initially brought into a threaded-in position at a distance from the roof frame structure, in which position the roof liner portion is positioned opposite an inner region of the roof frame member, and in that the roof module is subsequently brought into the inserted position by means of a feeding movement directed substantially perpendicularly to the bonding face, this movement being favorable for the adhesive connection. The method is advantageous because, owing to the positioning of the roof module into a threaded-in position, the corresponding roof liner portion does not have to be bent over in order to enable the roof module to be correctly inserted into the roof opening of the roof frame structure. The roof frame structure thus has the corresponding roof liner portion engaging below it during the insertion operation, with the result that the roof liner portion may also be fully provided with intended functional units, such as, for example, sun vizors, display systems and the like, without hereby impeding mounting of the roof module on the vehicle body. The method thus allows rapid and reliable mounting of a completely prefabricated roof module.

Advantageously, the adhesive connection between the roof module panel and the vehicle body is produced by means of a feeding movement which, with respect to the associated bonding faces, is substantially free of relative movement in the longitudinal and transverse directions. The feeding movement thus takes place by means of a displacement movement substantially in the perpendicular direction to the bonding faces. The production of such a bearing contact between the roof module panel and the roof frame structure is particularly favorable for the adhesive connection. Here, the feeding movement is preferably a displacement movement substantially in the perpendicular direction to the vehicle body. Accordingly, the bonding faces extend in a plane which is substantially defined by the longitudinal and transverse directions of the vehicle body.

The roof module is advantageously positioned into the threaded-in position by means of a combined displacement and pivoting movement. It is possible here for a plurality of suitable displacement and pivoting movements to be provided for positioning the roof module into the threaded-in position. The displacement movements may take place in the longitudinal direction and/or in the perpendicular direction to the vehicle body, while in addition mutually opposed and successive pivoting movements may be provided so that the roof module in the threaded-in position is then arranged at a substantially uniform distance from the roof frame structure.

According to a preferred variant embodiment, the roof module is pressed in a controlled manner onto the vehicle body during the production of the adhesive connection in the inserted position. This is particularly advantageous for producing a correct adhesive connection when using an adhesive layer in the form of an adhesive bead. To produce the adhesive connection, the roof module is preferably moved toward the roof frame structure uniformly, that is to say substantially only in the perpendicular direction to the vehicle body, thereby forming a bearing contact which is favorable for the adhesive connection.

Advantageously, the operations of threading in, feeding and pressing on the roof module are carried out in automated fashion by means of a suitable handling device. The handling device may for example be a robot system (robot arm), the use of which in the context of roof module mounting is already known per se.

In a development of the invention, after the roof module has assumed the inserted position, the roof liner portion is fastened in the inner region to a roof frame crossmember, in particular by adhesive bonding or by fixing in a nondestructively releasable manner by means of a touch-and-close fastener strip. The roof frame crossmember here may be a front and/or rear crossmember. The positioning of the roof module and the fastening of the roof liner portion may thus preferably be carried out with a single mounting tool. The fastening of the roof liner portion may, for example, be carried out by means of a double-sided adhesive tape.

The fastening of the roof liner portion is preferably carried out in the course of the operation of inserting the roof module into the roof opening. As a result, it is possible in a single mounting operation to position and fasten the roof module on the vehicle body and also to fasten the roof liner portion internally with respect to the vehicle body.

According to a preferred embodiment, the roof module has a front and/or a rear roof module panel portion with a connecting edge for a corresponding vehicle window, the roof module panel portion in the inserted position resting on the outside of the associated roof frame crossmember. A roof module designed in such a way can be connected quickly and reliably to the vehicle body by means of the method according to the invention.

Advantageously, the bonding face of the roof module and/or of the vehicle body is coated with an adhesive layer. The adhesive layer here is compressed during the feeding movement of the roof module in the direction of the vehicle body, forming a bearing contact.

Further advantages of the invention will emerge from the description.

The invention is explained in more detail below by way of a preferred exemplary embodiment with reference to a schematic drawing.

### BRIEF DESCRIPTION OF THE DRAWINGS

In the drawing:

FIG. 1 is a schematic side view of a vehicle body with a roof module during a mounting operation;

FIG. 2 shows a schematic sequence of movement for a roof module to be inserted into a vehicle body;

FIG. 3 shows a schematic detailed representation on an enlarged scale of a connecting region of a roof module situated in the threaded-in position, relative to a roof frame member of a vehicle body, and

FIG. 4 shows a schematic plan view of a vehicle body with a mounted roof module.

### DETAILED DESCRIPTION OF THE INVENTION

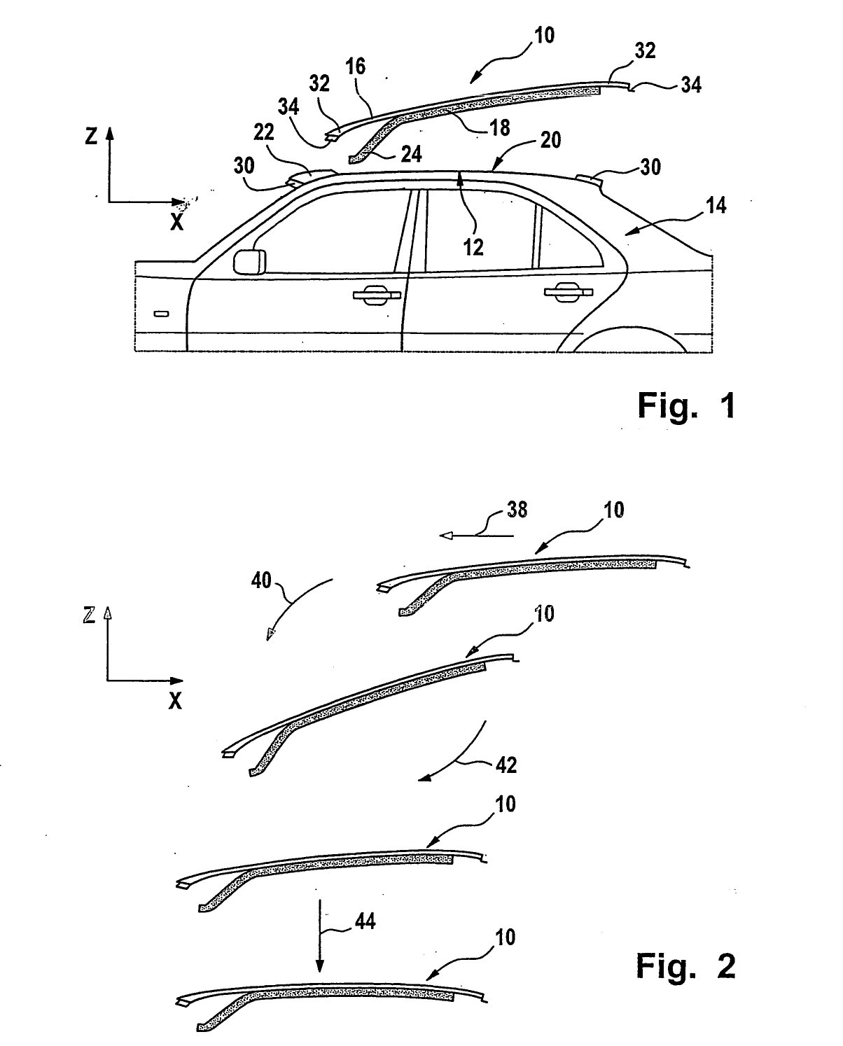

FIG. 1 is a schematic side view showing a vehicle body 14 on which a roof module 10 is to be mounted. At the same time FIG. 1 depicts an instantaneous view of the operation of mounting the roof module 10. The roof module 10 has a roof module panel 16 and a roof liner 18 which, according to the present exemplary embodiment, has a front roof liner portion 24 which projects from the roof module panel 16 during the mounting operation on account of the acting gravitational force, thereby forming a gap. The vehicle body 14 contains a roof frame structure 12 which is provided with a roof opening 20. The roof opening 20 here is tailored geometrically to the peripheral contour of the roof module 10. The vehicle body 14 contains a plurality of roof frame members 22 which bound the roof opening 20, with one roof frame crossmember 30 being provided at the front and rear of the vehicle body 14 respectively. The roof module 10 is to be mounted on the vehicle body 14 in such a way that the roof liner portion 24 is positioned below the front roof frame crossmember 30 and thus the roof module panel 16 can be brought from outside, relative to the roof frame structure 12, into bearing contact with the vehicle body 14. When the roof module 10 is situated in a defined inserted position, the roof module panel portions denoted by 32 are thus in bearing connection with the associated roof frame crossmembers 30 of the vehicle body 14, while the roof liner portion 24 which is still projecting on the inside of the vehicle body 14 can be fastened to the front roof frame crossmember 30.

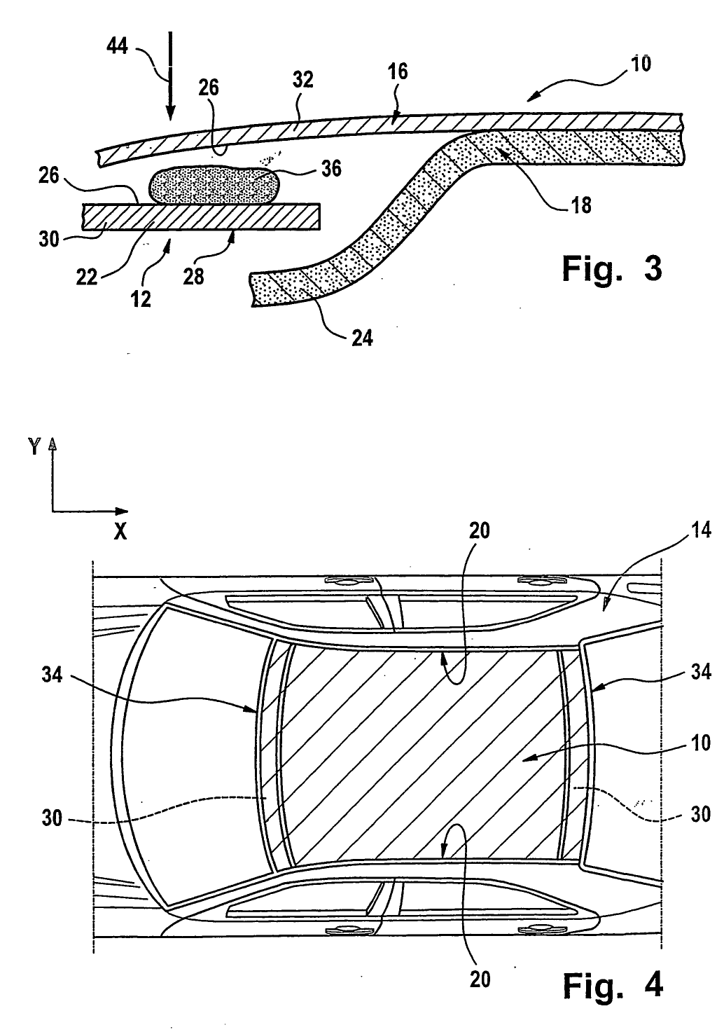

FIG. 2 schematically represents a possible sequence of movement for the roof module 10 during the mounting operation. The roof module 10 is initially positioned in the direction of arrow 38 (longitudinal direction X of the vehicle body 14) above the roof opening 20 and at a distance from the vehicle body 14 in order subsequently to be brought into a threaded-in position by means of suitable pivoting movements in the direction of the arrows 40, 42. In the threaded-in position, the roof module 10, that is to say the roof module panel 16 and the roof liner 18 and, in particular, the roof liner portion 24, is arranged at a distance from the vehicle body 14. This means that, after the threaded-in position has been assumed by the roof module 10, the front roof frame crossmember 30 of the roof frame structure 12 is situated within the gap between the front roof module panel portion 32 and the roof liner portion 24 projecting therefrom, without a bearing contact being present between these structural elements (see also FIG. 3). After the threaded-in position has been assumed, the roof module 10 is moved in the direction of arrow 44 of FIG. 2 by means of a substantially perpendicular feeding movement (vertical direction Z of the vehicle body 14) which is favorable for the adhesive connection, with the result that the roof module panel 16 can come into bearing contact with the roof frame structure 12 at the connecting faces. The roof module 10 is thus situated in the intended inserted position after the feeding movement in the direction of arrow 44.

FIG. 3 shows a schematic sectional representation of a detail of the connecting region between the front roof frame crossmember 30 and the roof module 10 in the threaded-in position. The means of connection provided here is an adhesive layer 36 which is applied to a bonding face 26 of the roof frame member 22 in order to be compressed after a feeding movement of the roof module 10 in the direction of arrow 44, thereby forming a correct adhesive connection between the roof frame structure 12 and the roof module 10. To produce a correct adhesive connection, the roof module 10 is positioned in the threaded-in position in such a way that bonding faces 26 which are to be connected to one another are at a defined distance from one another. Moreover, the roof liner portion 24 is also at a distance from an inner region 28 of the front roof frame crossmember 30 and arranged opposite the latter so that it can preferably likewise be adhesively connected to the front roof frame crossmember 30 in the inner region 28 after a reliable adhesive connection has been produced between the roof module panel 16 and the roof frame structure 12. Alternatively, or in addition, it is also possible for a corresponding adhesive layer to be provided on the roof module 10, with such a decision possibly being influenced by the stability of the adhesive to be used since, in principle, the adhesive layer should be prevented from flowing prior to the production of a corresponding adhesive connection.

FIG. 4 shows a schematic plan view of the vehicle body 14 of FIG. 1, in which the roof module 10 has been correctly inserted. The roof module 10 contains at both the front and rear a respective connecting edge 34 for a corresponding vehicle window. These connecting edges 34 are formed by the corresponding roof module panel portion 32 which, in the inserted position, lies on an associated roof frame crossmember 30 of the vehicle body 14, thereby forming a defined adhesive connection. The method described thus makes it possible for a roof module 10, which may be completely equipped with accessories, such as, for example, sun vizors, electrical displays and the like, to be mounted in a positionally exact manner in the longitudinal and transverse directions of the vehicle body 14 (X and Y direction) and at the same time makes it possible to dispense with the need to completely bend over protruding roof liner portions 24 of the roof module 10 to ensure trouble-free roof module mounting. This results in the process of mounting the roof module 10 being made considerably easier since the front roof liner portion 24 of the roof liner 18 in particular, by virtue of the roof module functional units preassembled in this region, may prove unfavorable for mounting because, in order to correctly insert the roof module 10, it would be absolutely essential for this roof liner portion 24 too to be temporarily bent over. By contrast, other roof liner portions which likewise project into the connecting region of the roof module panel 16 during roof module mounting, such as, for example, those on the longitudinal side and on the rear side of the roof module 10, may, if appropriate, be bent in the customary manner in the feeding direction (Z direction) without problems so as to enable the roof module 10 to be correctly inserted into the roof opening 20 of the roof frame structure 12.

1. A method for mounting a roof module (10) on a roof frame structure (12), having a roof opening (20), of a vehicle body (14), wherein the roof module (10), which contains a roof module panel (16) and a roof liner (18), is brought from outside into a defined inserted position relative to the roof opening (20), thereby forming an adhesive connection with the roof frame structure (12), and wherein the roof liner (18) in the inserted position has at least one roof liner portion (24) protruding over a roof frame member (22) of the roof frame structure (12),
wherein the roof module (10) is at least temporarily positioned relative to the roof opening (20) by means of a movement component in the longitudinal direction (X) of the vehicle body in such a way that the roof module (10) is initially brought into a threaded-in position at a distance from the roof frame structure (12), in which position the roof liner portion (24) is positioned opposite an inner region (28) of the roof frame member (22), and
wherein the roof module (10) is subsequently brought into the inserted position by means of a feeding movement directed substantially perpendicularly to the bonding face (26), this movement being favorable for the adhesive connection.

2. The method as claimed in claim 1, wherein the adhesive connection between the roof module panel (16) and the vehicle body (14) is produced by means of a feeding movement which, with respect to the associated bonding faces (26), is substantially free of relative movement in the longitudinal and transverse directions (X, Y).

3. The method as claimed in claim 1, wherein the feeding movement is a displacement movement substantially in the perpendicular direction (Z) to the vehicle body (14).

4. The method as claimed in claim 1, wherein the roof module (10) is positioned into the threaded-in position by means of a combined displacement and pivoting movement (38, 40, 42, 44).

5. The method as claimed in claim 1, wherein the roof module (10) is pressed in a controlled manner onto the vehicle body (14) during the production of the adhesive connection in the inserted position.

6. The method as claimed in claim 5, wherein the operations of threading in, feeding and pressing on the roof module (10) are carried out in automated fashion by means of a suitable handling device.

7. The method as claimed in claim 1, wherein, after the roof module (10) has assumed the inserted position, the roof liner portion (24) is fastened in the inner region (28) to a roof frame crossmember (30), in particular by adhesive bonding or by fixing in a nondestructively releasable manner by means of a touch-and-close fastener strip.

8. The method as claimed in claim 7, wherein the fastening of the roof liner portion (24) is carried out in the course of the operation of inserting the roof module (10) in the roof opening (20).

9. The method as claimed in claim 1, wherein the roof module (10) has a front and/or a rear roof module panel portion (32) with a connecting edge (34) for a corresponding vehicle window, the roof module panel portion (32) in the inserted position resting on the outside of the associated roof frame crossmember (30).

10. The method as claimed in claim 1, wherein the bonding face (26) of the roof module (10) and/or of the vehicle body (14) is coated with an adhesive layer (36).
